(19) United States
(12) Patent Application Publication
(10) Pub. No.: US 2019/0249770 A1
(43) Pub. Date: Aug. 15, 2019

(54) METHOD FOR SYNCHRONISING AN IDLER GEAR ON A GEARBOX SHAFT

(71) Applicant: NISSAN MOTOR CO., LTD., Yokohama-shi, Kanagawa (JP)

(72) Inventor: Ludovic MERIENNE, Gif-sur-Yvette (FR)

(73) Assignee: NISSAN MOTOR CO., LTD., Yokohama-shi, Kanagawa (JP)

(21) Appl. No.: 16/335,033

(22) PCT Filed: Jul. 11, 2017
(86) PCT No.: PCT/FR2017/051909

§ 371 Date: Mar. 20, 2019

(30) Foreign Application Priority Data
Sep. 23, 2016 (FR) 1658953

(51) Int. Cl. F16H 61/04; F16H 59/18

(52) U.S. Cl. CPC F16H 61/0403; F16H 2061/0422; F16H 2059/183; F16H 59/18

(57) ABSTRACT

A method for synchronising an idler gear before coupling of same on a secondary shaft of a parallel-shaft gearbox comprising at least one primary shaft connected to a drive source of a vehicle, at least one secondary shaft carrying the idler gear for transmitting the torque from the drive source to the wheels of the vehicle at a transmission ratio, and at least one coupling means for coupling the idler gear to the shaft of same having no mechanical synchronisation members, characterised in that the drive source is controlled, before the coupling, at a speed imposing a differential speed with respect to the synchronisation speed thereof at the transmission ratio which is to be engaged, this differential being determined as a function of the quantity of energy absorbed by the vehicle at the time of coupling in response to the disappearance of the differential.

The present invention relates to the field of the control of gearshifts in a gearbox.

More precisely, the object of the invention is a method for synchronizing an idler gear before coupling of same on a secondary shaft of a parallel-shaft gearbox containing at least one primary shaft connected to a drive source of a vehicle, at least one secondary shaft carrying the idler gear for transmitting the torque from the drive source to the wheels of the vehicle at a transmission ratio, and at least one means of coupling the idler gear its shaft without mechanical synchronization members.

This invention is applicable to any hybrid or electrical transmission having parallel shafts, in which the synchronization of the gear wheels that are freely rotatable on a shaft connected to the wheels of the vehicle is assured thanks to the control, in respect of its torque or speed, of an electrical or thermal source of traction. It finds a preferred, albeit non-restrictive, application when the means of coupling displaced on the shaft in order to ensure the mechanical connection of an idler gear equipped with dogging teeth having a flat face, or dogs.

This invention is of particular interest for a hybrid power train composed of a thermal engine connected to a first gearbox input shaft which is able to transmit its torque to the wheels at different transmission ratios, a first electrical machine connected to a second input shaft thereof, and a second electrical machine connected alternately to the first or the second input shaft of the box.

When the member for coupling the idler gear on its shaft is not associated with a mechanical synchronization member permitting its speed differential to be reduced before coupling, and when a source of traction remains linked to the primary shaft of the box, synchronization of the idler gear on its shaft is performed by controlling the source of traction during operation.

Familiar from publication FR 2 988 799 is a method for synchronizing a gear on a gearbox shaft, in which a source of energy is controlled in order to produce a signal for controlling the reference torque, equal to the minimum transmissible torque, in order to minimize the difference between the primary speed and the secondary speed multiplied by the reduction ratio.

In order to be able to engage a ratio by controlling the synchronization of the dog and the idler gear, it is necessary to establish a speed differential between these elements, which is generally fixed in such a way as to limit the duration of tooth-against-tooth blocking, in order to permit the dogs of the idler to be inserted between two teeth of the idler gear. The speed differential may be regulated, for example, around 50 rpm. During coupling, it disappears instantaneously, because the speed of the source of traction is brought instantaneously to a value that is imposed on it by the secondary shaft at the new ratio. The controlled source of traction receives a shock, of which the energy is absorbed by the vehicle. Beyond a certain quantity of absorbed energy, the shock is perceived uncomfortably by the occupants of the vehicle.

The aim of the present invention is to avoid these disadvantages associated with the controlled synchronization of the coupling speeds.

For this purpose, it proposes that the drive source is controlled at a speed imposing on it, before coupling, a certain differential with respect to the synchronization speed thereof at the transmission ratio which is to be engaged. The speed differential is determined as a function of the quantity of energy absorbed by the vehicle at the time of coupling in response to the disappearance of the differential.

Preferably, it is calculated in order to maintain the quantity of energy absorbed by the vehicle below a tolerance threshold.

The present invention will be more readily appreciated from a perusal of the following description of a particular embodiment thereof, with reference to the accompanying drawings, in which:

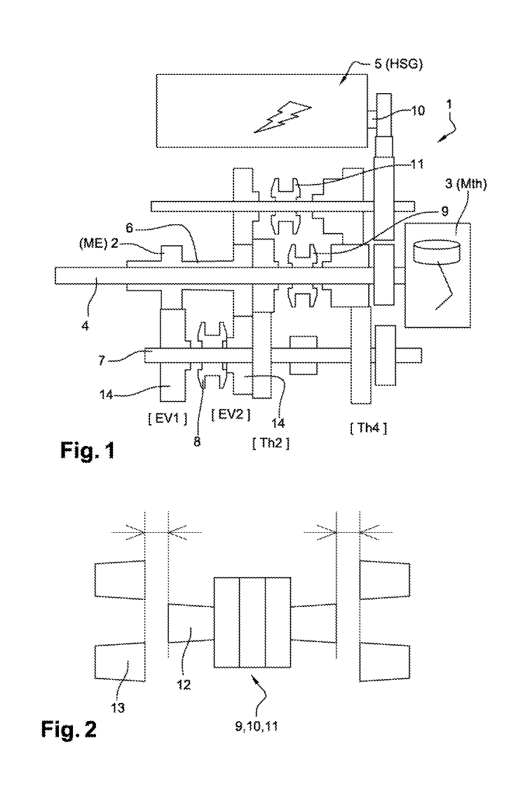

FIG. 1 is an architecture diagram of a hybrid gearbox,

FIG. 2 illustrates the coupling of a gear,

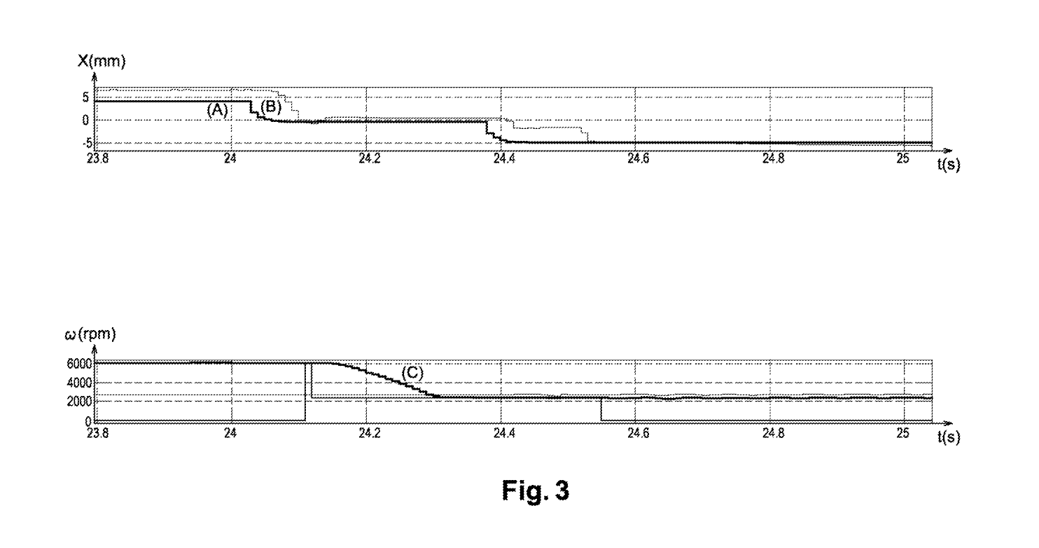

FIG. 3 reproduces curves for the position and speed of the during a shift, and

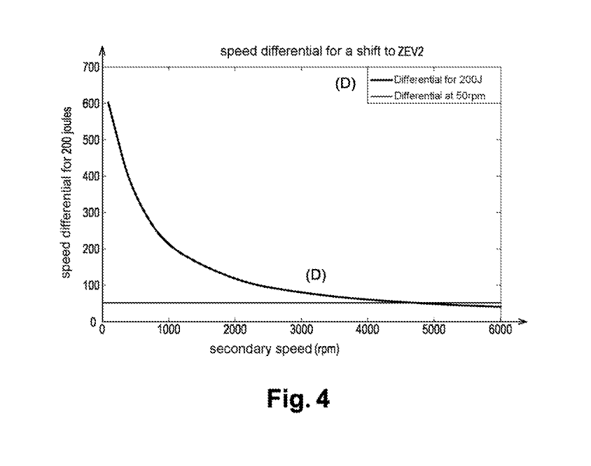

FIGS. 4, 5 and 6 reproduce curves for the differential speed as a function of the speed of the secondary shaft of the box.

The gearbox 1 in FIG. 1 is of the “robotized” type, for example, that is to say its function is that of a manual box, although the gearshifts are automated. An electrical machine, referred to as an HSG (for hybrid starter-generator) 5, a thermal engine 3 on a solid primary shaft 4, are represented in the diagram. Another electrical machine 2, referred to as an ME, being more powerful than the first, is mounted on a hollow primary shaft 6. The secondary shaft of the box is connected to the differential (not illustrated) and then to the wheels of the vehicle.

The first means of coupling 8, situated on the secondary shaft 7, permits the modification of the ratio of the electrical machine ME 2 in a manner that is independent of the rest of the box, in order to have available two electrical ratios [EV1] and [EV2]. The second means of coupling 9, situated on the solid primary shaft 4, permits the modification of the ratio of the thermal engine 3 in a manner that is independent of the electrical ratios, in order to establish two thermal ratios [Th2] and [Th4], independently of the electrical ratio. The third means of coupling 11, situated on the transfer shaft 10, permits the establishment of a third thermal ratio [Th3] when it moves towards the right in the diagram. It is possible, at all times, to select in an independent manner the desired ratio on the first electrical machine 2 (ME) and that desired on the thermal engine 3 (Mth) and the second electrical machine 5 (HSG). The combinations of the thermal ratios and the electrical ratios permit hybrid ratios to be achieved.

The gearbox in FIG. 1 is a hybrid gearbox, of which the coupling members do not have any means of mechanical synchronization (synchronizers) and exhibit flat dogging teeth 12, generally referred to as “dogs”, coming into engagement with coupling teeth 13, likewise flat, of the gears, as indicated in FIG. 2. The dog systems do not have an integrated synchronization device. However, the engagement of the ratio can only take place after having reduced the difference in speed between the gear and its shaft, up to a controlled differential, permitting the “dogging” or “dog-clutching” of the gear. In FIG. 2, the means of coupling 9, 10 or 11 is in neutral, in a central position, at equal distance from two gear wheels (not illustrated) having flat teeth 13.

FIG. 3 relates to a shift from a first electrical ratio EV1 (low ratio) towards a second ratio EV2 (high ratio) in the gearbox in FIG. 1. It shows the different stages of the shift. The first curves (A) and (B) show the setpoint position of the dog (A) and its measured position (B). Beyond 5 mm, a first ratio EV1 is engaged. Below −5 mm, a second ratio EV2 is engaged. In order to change the ratio between EV1 and EV2, the ratio EV1 is abandoned by placing the dog in the neutral position at 0 mm (no ratio engaged). The ME is then controlled to rotate at a speed (curve C) permitting the engagement of the ratio EV2, changing from 6000 rpm to about 2200 rpm. Once the ME has stabilized at a speed ensuring the correct speed differential at the dog, the dog may be engaged. As indicated above, at the moment of dogging, the ME moves abruptly from a speed ensuring a differential at the dog to its speed of synchronism.

The gear is synchronized and coupled with the secondary shaft of the gearbox, which is a parallel shaft box containing at least one primary shaft connected to a drive source of a vehicle, at least one secondary shaft carrying the idler gear 14 in order to transmit the torque from the drive source to the wheels of the vehicle at a transmission ratio, and at least one means of coupling the gear. The means of coupling does not have any mechanical synchronization members. During coupling, the drive source responsible for control, in this case the electrical machine ME, experiences a jump in speed imposed by the secondary shaft. The energy absorbed by the ME is absorbed by the vehicle. In this example, the speed of the electrical machine reduces in the event of an upshift from EV1 towards EV2, since the demultiplication ratio of the gears EV1 is 2.26 and that of EV2 is 0.87. If, just before changing ratio, the electrical machine was rotating at 6000 rpm, the secondary shaft was rotating at (6000/2.26), or ω2=about 2650 rpm at the ratio EV1. In order to ensure dogging under the best possible conditions, that is to say assuredly with dogs between the teeth of the gear 14, the ME is controlled, not at the exact speed of synchronization, but in order for a speed differential of about 50 rpm to exist between the dogs and the gear during dogging. This value is determined as a function of the maximum time of prevention of “tooth-on-tooth” dogging between the dogs and the gear 14. In the example described here, it is proposed, for example, for dogging to take place at a speed of the ME corresponding to a speed at the idler gear of 2700, in such a way as to propose a differential of 50 rpm between the dogs and the gear during dogging. The ME moves abruptly from 2700×0.87=2349 rpm (ω1) to 2650×0.87=2305 rpm (ω2) at the instant of dogging. Considering that the motor has an inertia of 0.05 kg/m², the energy E absorbed by the vehicle at the moment of dogging at the ratio EV2 is:

E=J(ω₁²−ω₂²)=0.05*(246²−241²)=121 joules

For the downshift from EV2 to EV1, at the same secondary speed of 2650 rpm, the speed the idler gear of EV1 must be regulated to the speed of 2700 rpm for a speed of the ME ω=6102 rpm. The speed of the ME moves abruptly to 6000 rpm at the moment of dogging. The vehicle absorbs an energy E:

E=J(ω₁²−ω₂²)=0.05*(639²−628²)=697 joules

The quantity of energy to be absorbed at the moment of dogging is about six times greater than previously. It generates a shock, which is perceived in particular in the event of shifts to EV1 at high speed. In order to avoid this perception, the invention proposes to modulate the speed differential at the level of the dog in a particular manner: not only as a function of the maximum possible time of “tooth-on-tooth”, but also as a function of the energy to be absorbed by the vehicle when dogging. The drive source is thus controlled before coupling at a speed imposing on it a differential speed with respect to the synchronization speed thereof at the transmission ratio which is to be engaged. The differential is thus determined as a function of the quantity of energy absorbed by the vehicle at the time of coupling, in response to the disappearance of the abrupt differential.

A reduction in the speed differential, starting from a certain secondary speed, is chosen in order to limit the quantity of energy E absorbed. It is then calculated in order to maintain the quantity of energy absorbed by the vehicle below a tolerance threshold at the time of the disappearance of the differential.

The energy E absorbed as a function of the differential, and of the speed of the secondary shaft, may be written as:

E−J((α(ω+δ))²−(αω)²).

an expression in which:
E is the energy to be absorbed at the moment of dogging,
J is the inertia of the electrical machine and the gears in direct contact,
α is the demultiplication ratio of the target ratio,
ω is the secondary speed, and
δ is the speed differential at the dog.
   In order to propose a level of energy E to be absorbed at a given speed ω of the secondary, the speed differential must be equal to:

$$δ = ω ( \sqrt{1 + \frac{E}{J {α}^{2} {ω}^{2}}} - 1 )$$

The curve (D) for the speed differential in order to have 200 Joules of energy available for a shift to EV2 as a function of the speed of the ME is plotted in FIG. 4. Below this curve, the threshold of 200 Joules is not reached. Up to 5000 rpm, the curve (D) is above 50 rpm. It is not necessary to increase the differential in order to meet the objective of 200 Joules. This is no longer the case from 5000 revolutions, since the curve (D) passes beneath the threshold of 50 rpm (curve (E)). There is no need to increase the differential to 5000 rpm, since the value of 50 rpm already meets the maximum time constraint in tooth-against-tooth. It is thus possible to create a differential map for shifts to EV2 by taking the minimum between the blue and green curves (D) and (E) in FIG. 4.

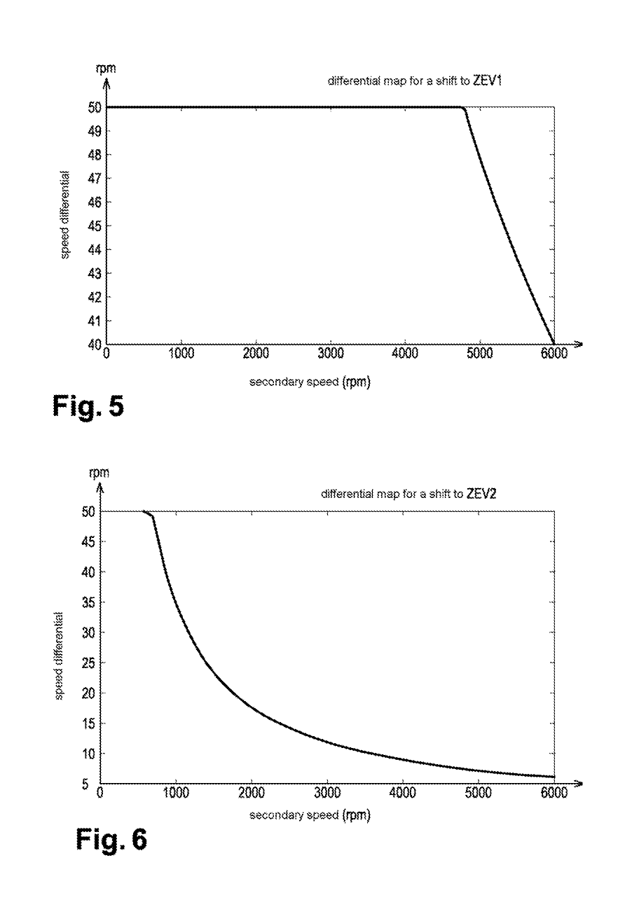

The invention proposes in particular to maintain the speed differential at a constant reference value up to a speed threshold of the secondary shaft, beyond which it reduces as a function thereof, in order to meet the tolerance threshold of absorbed energy. The map in FIG. 5 is obtained. In the case of a shift from EV2 to EV1, the dissipated energy is greater, and the map in FIG. 6 is obtained as a function of the values indicated above for information purposes. In order to meet the same objective and to preserve the shifting comfort, this shift imposes a reduction in the speed differential from 600 rpm.

As in the example described above, the reference value of the speed differential is advantageously 50 rpm. In order to implement this method under the best possible conditions, the invention also proposes adopting the following practical measures:
determine the constant value of the speed differential as a function of a meshing time constraint to be met between elements of the means of coupling and the idler gear in order to guarantee their coupling, and/or
determine the meshing time constraint as a function of the surface of entry into contact of dogs of the means of coupling with coupling teeth of the idler gear during the progression of the means of coupling towards the idler gear.

The gearshifts considered above are shifts of electrical ratios. Nevertheless, without departing from the scope of the invention, the same type of analysis may be performed for shifts of thermal ratios, and the method applied in order to control the energy absorbed by the vehicle during passages is the same.

Finally, it may be necessary to force the differential to 50 rpm, even if the map gives a lower value thereof, in cases of “down-shifting” in response to a depression of the accelerator pedal, for example of the “kick down” type. In fact, a reduction in the speed differential causes the shock perceived during dogging to disappear, but may lead to a longer tooth-against-tooth blockage during dogging. The gear shift may be slightly longer, however. In certain cases of down-shifting in response to the depression of the accelerator pedal of the vehicle by the driver, the speed differential may thus be maintained at its reference value, whereas the tolerance threshold of absorbed energy is exceeded. Dogging takes 150 ms on average for a differential at 50 rpm. By dividing the differential by two, the shifting time is doubled. If the driver desires strong acceleration, the differential is forced to 50 rpm in order to keep the dogging sufficiently rapid. The shock is more acceptable in the case of foot-to-the-floor acceleration.

The invention permits a significant improvement in the quality of shifting of hybrid ratios in a gearbox such as that in FIG. 1 by integrating a new dimension into the calculation of the speed differential for dogging. Its implementation requires only a software modification to the calculation of the differential, henceforth being dependent on the speed of the secondary shaft and of the gradient of the position of the accelerator pedal, in order to identify cases of “kick down”, for example.

Within the scope of the invention, the speed differential is established by operating an electrical traction machine of the vehicle, a thermal traction engine of the vehicle, or one or other of a plurality of drive sources, according to the mode of operation of a hybrid transmission having a plurality of drive sources.

1.-10. (canceled)

11. A method for synchronizing an idler gear before coupling of same on a secondary shaft of a parallel-shaft gearbox containing at least one primary shaft connected to a drive source of a vehicle, at least one secondary shaft carrying the idler gear for transmitting the torque from the drive source to the wheels of the vehicle at a transmission ratio and at least one means of coupling the idler gear to the shaft of same having no mechanical synchronization members, characterized in that the drive source is controlled, before coupling, at a speed imposing on it a differential speed with respect to the synchronization speed thereof at the transmission ratio which is to be engaged, this differential being determined as a function of the quantity of energy absorbed by the vehicle at the time of coupling in response to the disappearance of the differential.

12. The method for synchronizing as claimed in claim 11, characterized in that the speed differential is calculated in order to maintain the quantity of energy absorbed by the vehicle below a tolerance threshold at the time of the disappearance of the differential.

13. The method for synchronizing an idler gear as claimed in claim 12, characterized in that the speed differential is maintained at a constant reference value up to a speed threshold of the secondary shaft, beyond which it reduces as a function thereof in order to meet the tolerance threshold of absorbed energy.

14. The method for synchronizing an idler gear as claimed in claim 13, characterized in that the reference value of the differential is determined as a function of a meshing time constraint to be met between elements of the means of coupling and the idler gear in order to guarantee their coupling.

15. The method for synchronizing an idler gear as claimed in claim 14, characterized in that the meshing time constraint is determined by the surface of entry into contact of dogs (12) of the means of coupling with coupling teeth (13) of the idler gear (14) during the progression of the means of coupling towards the idler gear.

16. The method for synchronizing an idler gear as claimed in claim 13, characterized in that the speed differential is maintained at its reference value, whereas the tolerance threshold of absorbed energy is exceeded, in certain cases of down-shifting, in response to the depression of the accelerator pedal of the vehicle by the driver.

17. The method for synchronizing an idler gear as claimed in claim 11, characterized in that the reference value of the speed differential is of the order of 50 rpm.

18. The method for synchronizing an idler gear as claimed in claim 11, characterized in that the speed differential is established by operating an electrical traction machine of the vehicle.

19. The method for synchronizing an idler gear as claimed in claim 11, characterized in that speed differential is established by operating a thermal traction engine of the vehicle.

20. The method for synchronizing an idler gear as claimed in claim 18, characterized in that the speed differential is established by controlling one or other of a plurality of drive sources according to the mode of operation of a hybrid transmission having a plurality of drive sources.

21. The method for synchronizing an idler gear as claimed in claim 19, characterized in that the speed differential is established by controlling one or other of a plurality of drive sources according to the mode of operation of a hybrid transmission having a plurality of drive sources.
